(19) United States
(12) Patent Application Publication
(10) Pub. No.: US 2006/0022164 A1
(43) Pub. Date: Feb. 2, 2006

(54) Structure air compressor air (water) release valve

(76) Inventor: Hui-Chun Su, Changhua Hsien (TW)

Correspondence Address: RABIN & BERDO, P.C., Suite 500, 1101 14th Street, N.W., Washington, DC, 20005, US

(21) Appl. No.: 10/900,381

(22) Filed: Jul. 28, 2004

(51) Int. Cl. F16K 31/00

(52) U.S. Cl. 251/344

(57) ABSTRACT

An improved structure air compressor air (water) release valve, wherein the air (water) release valve is comprised of a valve stem, a valve seat, and a knob. The valve seat that enable fastening to the bottom portion of the air compressor storage tank. The major feature of the present invention is that the valve stem has a circular groove around its top extremity, the circular groove providing for the placement of an O-ring. As such, when the knob is rotated, the valve stem moves downward, and the O-ring on the valve stem is situated firmly against the valve seat beveled edge, thereafter constituting a tightly sealed state whereby gas leakage cannot occur in the air (water) release valve structure.

### BACKGROUND OF THE INVENTION

1) Field of the Invention

The invention herein relates to an improved structure air compressor air (water) release valve that addresses the gas leakage problem of prior art arrangements.

2) Description of the Prior Art

In conventional air compressor air (water) release valve structures, as indicated in FIG. 1 and FIG. 2, the said air (water) release valve A is typically comprised of a valve stem B, a valve seat C, and a knob D; the said valve stem B is inserted into the valve seat C, following which the knob D riveting hole D1 is riveted to the bottom extremity; the said valve stem B also has a beveled surface B1 at the top extremity, a passage B2 through the top section, threads B3 died along the bottom section, and a deep bore B4 inside; furthermore, there are matching threads on the valve seat C that enable fastening to the bottom portion of the air compressor storage tank Q and a threaded hole C1 is tapped inside, the threaded hole C1 having a beveled edge C2; as such, when the knob D is rotated, the valve stem B moves downward, and the valve stem B beveled surface B1 is situated firmly against the valve seat C beveled edge C2, thereafter achieving a tightly sealed state; in other words, rotating the knob D to move the valve stem B upward enables functioning as a release valve of the gas (water) contained in the storage tank Q. However, since the closure of the valve stem B against the valve seat C beveled edge C2 involves a very high degree of precision tolerance dimensions, the conventional air (water) release valve allows occurrences of major or minor gas leakage during utilization and as a release valve is incapable of achieving fully sealed gaseous containment; therefore, in order to effectively solve this problem, the applicant of the invention observed the said shortcoming and concluded that the entire prior art structure required improvement, and further optimized the said sealed closuring capability of the said air compressor air (water) release valve, resulting in the successful development of the content of the present invention following extensive testing and experimentation, which is submitted as a new patent application.

### SUMMARY OF THE INVENTION

The primary objective of the invention herein is to provide an improved structure air compressor air (water) release valve that addresses and remedies the occurrence of major or minor gas leakage during utilization and release valve incapability to achieve fully sealed gaseous containment, the present invention capable of a demonstrably workable closure that effectively prevents gas leakage.

To enable the examination committee a further understanding of the structural features, operation, and other items of the present invention, the brief description of the drawings below are followed by the detailed description of the invention herein.

### BRIEF DESCRIPTION OF THE DRAWINGS

FIG. 1 is an exploded drawing of the prior art structure.

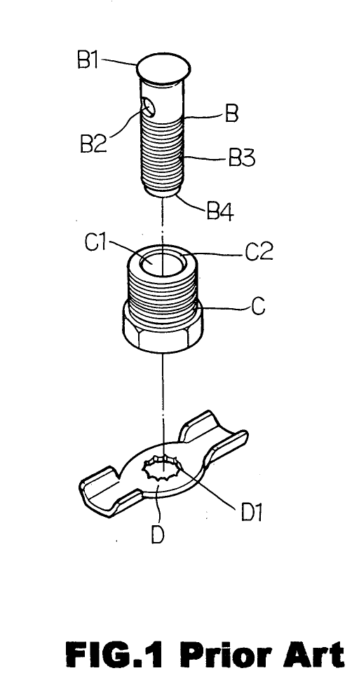

FIG. 2 is a cross-sectional drawing of the prior art air (water) release valve installed on an air compressor air storage tank.

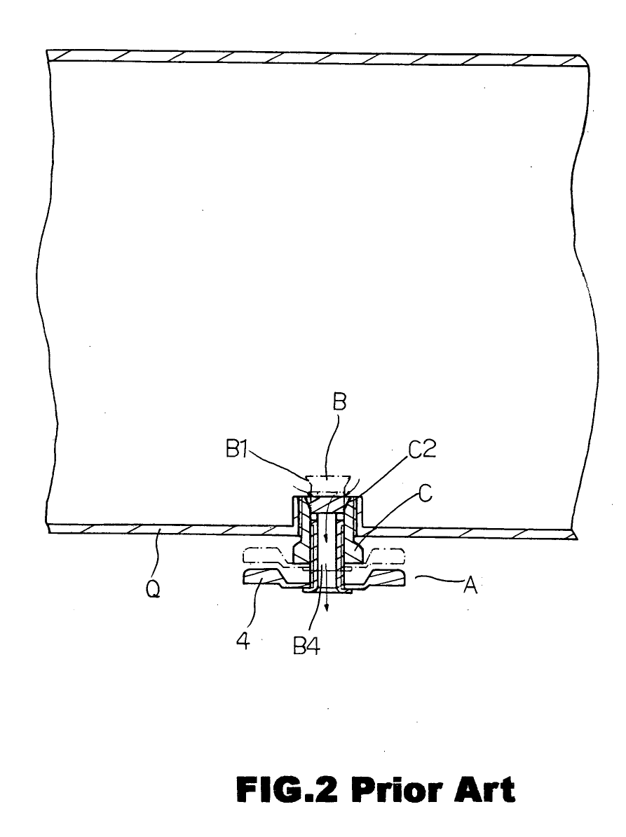

FIG. 3 is an isometric drawing of the invention herein.

FIG. 4 is an exploded drawing of the invention herein.

FIG. 5 is a cross-sectional drawing of the air (water) release valve of the invention herein installed on an air compressor air storage tank.

FIG. 6 is an orthographic drawing of the air (water) release valve of the invention herein installed on an air compressor.

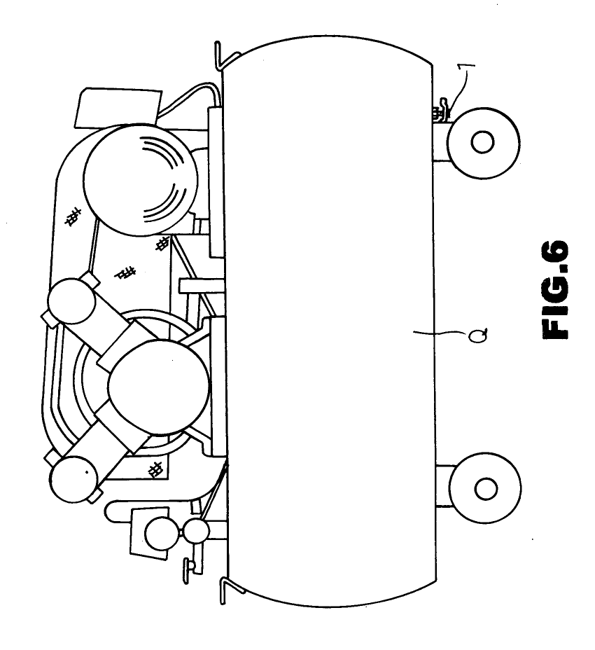

### DETAILED DESCRIPTION OF THE INVENTION

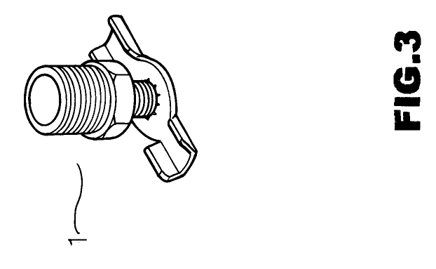

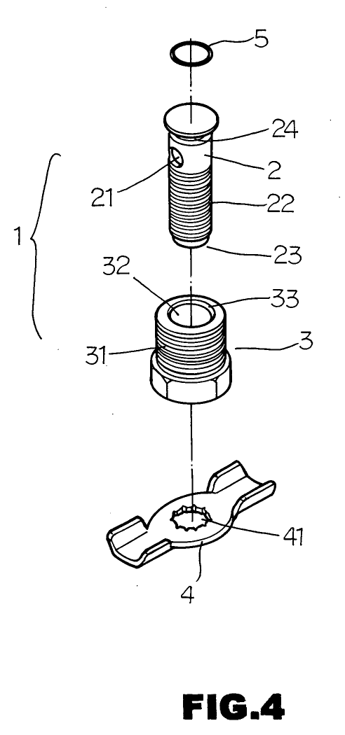

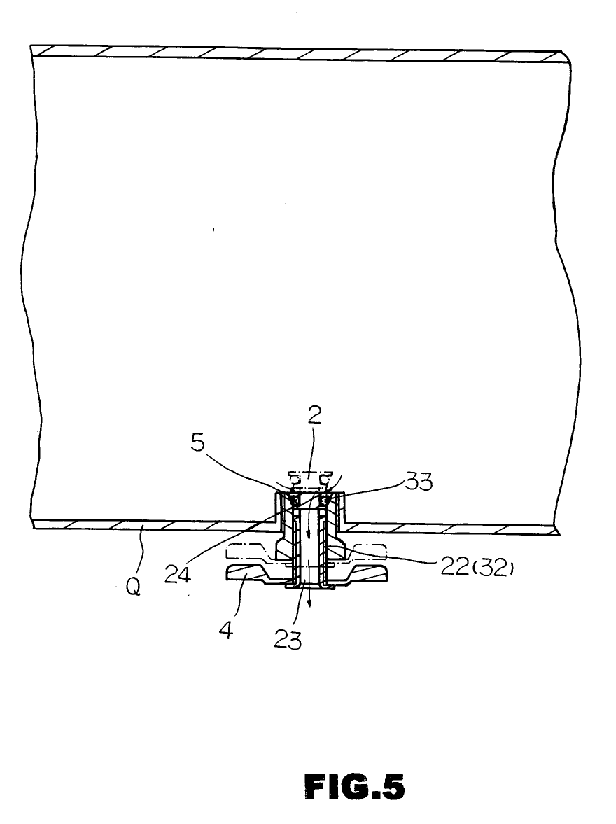

Referring to FIG. 3, FIG. 4, and FIG. 5, in the improved structure air compressor air (water) release valve of the invention herein, the said air (water) release valve 1 is comprised of a valve stem 2, a valve seat 3, and a knob 3; having a passage 21 through the top section, threads 22 died along the bottom section, and a deep bore 23 inside, the said valve stem 2 is inserted into the valve seat 3 and afterwards the knob 3 riveting hole 41 is riveted to the bottom extremity; furthermore, there are matching threads 31 on the valve seat 3 that enable fastening to the bottom portion of the air compressor storage tank Q, and a threaded hole 32 is tapped inside, the threaded hole 32 having a beveled edge 33; the major feature is: The said valve stem 2 has a circular groove 24 around its top extremity, the said circular groove 24 providing for the placement of an O-ring 5 such that when the knob 4 is rotated, the valve stem 2 moves downward, and the O-ring 5 on the valve stem 2 is situated firmly against the valve seat 3 beveled edge 33, thereafter constituting a tightly sealed state whereby gas leakage cannot occur in the air (water) release valve 1 structure.

In summation of the foregoing section, since the structure of the invention herein is definitely capable of achieving the advantage of a fully sealed containment when utilized such that the leakage of gas is not possible, the present invention meets new patent application requirements and is submitted to the patent bureau for review and the granting of the commensurate patent rights.

1. An improved structure air compressor air (water) release valve in which the said air (water) release valve is comprised of a valve stem, a valve seat, and a knob; having a passage through the top section, threads died along the bottom section, and a deep bore inside, the said valve stem is inserted into the said valve seat and afterwards the riveting hole of the said knob is riveted to the bottom extremity; furthermore, there are matching threads on the said valve seat that enable fastening to the bottom portion of the air compressor storage tank, and a threaded hole is tapped inside, the said threaded hole having a beveled edge; the major feature is: The said valve stem has a circular groove around its top extremity, the said circular groove providing for the placement of an O-ring such that when the said knob is rotated, the said valve stem moves downward, and the said O-ring on the said valve stem is situated firmly against the said valve seat beveled edge, thereafter constituting a tightly sealed state whereby gas leakage cannot occur in the said air (water) release valve 1 structure.
